(19) United States
(12) Patent Application Publication
(10) Pub. No.: US 2016/0267924 A1
(43) Pub. Date: Sep. 15, 2016

(54) SPEECH DETECTION DEVICE, SPEECH DETECTION METHOD, AND MEDIUM

(71) Applicant: NEC CORPORATION, Minato-ku, Tokyo (JP)

(72) Inventors: Makoto TERAO, Tokyo (JP); Masanori TSUJIKAWA, Tokyo (JP)

(73) Assignee: NEC Corporation, Tokyo (JP)

(21) Appl. No.: 15/030,477

(22) PCT Filed: May 8, 2014
(86) PCT No.: PCT/JP2014/062360

§ 371 Date: Apr. 19, 2016

(30) Foreign Application Priority Data
Oct. 22, 2013 (JP) 2013-218934

(51) Int. Cl. G10L 25/84; G10L 25/21; G10L 25/18; G10L 25/51

(52) U.S. Cl. CPC G10L 25/84; G10L 25/51; G10L 25/21; G10L 25/18

(57) ABSTRACT

A speech detection device according to the present invention acquires an acoustic signal, calculates a sound level for first frames in the acoustic signal, determines the first frame having the sound level greater than or equal to a first threshold value as a first target frame, calculates a feature value representing a spectrum shape for second frames in the acoustic signal, calculates a ratio of a likelihood of a voice model to a likelihood of a non-voice model for the second frames with the feature value as an input, determines the second frame having the likelihood ratio greater than or equal to a second threshold value as a second target frame, and determines a section included in both a first target section corresponding to the first target frame and a second target section corresponding to the second target frame as a target voice section including the target voice.

### TECHNICAL FIELD

The present invention relates to a speech detection device, a speech detection method, and a program.

### BACKGROUND ART

A voice section detection technology is a technology of detecting a time section in which voice (human voice) exists from an acoustic signal. Voice section detection plays an important role in various types of acoustic signal processing. For example, in speech recognition, insertion errors may be suppressed and voice may be recognized while reducing a processing amount, by taking only a detected voice section as a recognition target. In noise tolerance processing, sound quality of a voice section may be increased by estimating a noise component from a non-voice section in which voice is not detected. In voice coding, a signal may be efficiently compressed by coding only a voice section.

The voice section detection technology is a technology of detecting voice. However, in general, unintended voice is treated as noise, despite being voice, and is not treated as a detection target. For example, when voice detection is used for performing speech recognition on conversational content via a mobile phone, voice to be detected is voice generated by a user of the mobile phone. As for voice included in an acoustic signal transmitted/received by a mobile phone, various types of voice may be considered in addition to voice generated by the user of the mobile phone, such as voice in conversations of people around the user, announcement voice in station premises, and voice generated by a TV. Such voice types should not be detected. Voice to be a target of detection is hereinafter referred to as “target voice” and voice treated as noise instead of a target of detection is referred to as “voice noise.” Further, various types of noise and silence may be collectively referred to as “non-voice.”

NPL 1 proposes a technique of determining whether each frame in an acoustic signal is voice or non-voice in order to increase voice detection precision in a noise environment by comparing a predetermined threshold value with a weighted sum of four scores calculated in accordance with respective features of an acoustic signal as follows: an amplitude level, a number of zero crossings, spectrum information, and a log-likelihood ratio between a voice GMM and a non-voice GMM with a mel-cepstrum coefficient as an input.

### CITATION LIST

### Patent Literature

[PLT 1] Japanese Patent No. 4282227

### Non Patent Literature

[NPL 1] Yusuke Kida and Tatsuya Kawahara, “Voice Activity Detection based on Optimally Weighted Combination of Multiple Features,” Proc. INTERSPEECH 2005, pp. 2621-2624, 2005

### SUMMARY OF INVENTION

### Technical Problem

However, the aforementioned technique described in NPL 1 may not be able to properly detect a target voice section in an environment in which various types of noise exist simultaneously. The reason is that, in the aforementioned technique, optimum weight values in integration of the scores vary by noise type.

For example, in order to detect target voice in an environment in which noise such as a door-closing sound or a traveling sound of a train exists, a weight of the amplitude level needs to be decreased and a weight of the GMM log likelihood needs to be increased when integrating the scores. By contrast, in order to detect target voice in an environment in which voice noise such as announcement voice in station premises exists, a weight of the amplitude level needs to be increased and a weight of the GMM log likelihood needs to be decreased when integrating the scores. Consequently, the aforementioned technique may not be able to properly detect a target voice section because proper weighting does not exist in an environment in which two or more types of noise, such as a traveling sound of a train and announcement voice in station premises, having different optimum weights in score integration, exist simultaneously.

The present invention is made in view of such a situation and provides a technology of detecting a target voice section with high precision even in an environment in which various types of noise exist simultaneously.

### Solution to Problem

According to the present invention, a speech detection device is provided. The speech detection device includes:

acoustic signal acquisition means for acquiring an acoustic signal;

sound level calculation means for performing a process of calculating a sound level for each of a plurality of first frames obtained from the acoustic signal;

first voice determination means for determining a first frame having the sound level greater than or equal to a first threshold value as a first target frame;

spectrum shape feature calculation means for performing a process of calculating a feature value representing a spectrum shape for each of a plurality of second frames obtained from the acoustic signal;

likelihood ratio calculation means for calculating a ratio of a likelihood of a voice model to a likelihood of a non-voice model for each of the plurality of second frames using the feature value as an input;

second voice determination means for determining a second frame having the ratio greater than or equal to a second threshold value as a second target frame; and

integration means for determining, in the acoustic signal, a section included in both a first target section corresponding to the first target frame and a second target section corresponding to the second target frame as a target voice section including a target voice.

According to the present invention, a speech detection method performed by a computer is provided. The method includes:

an acoustic signal acquisition step of acquiring an acoustic signal;

a sound level calculation step of performing a process of calculating a sound level for each of a plurality of first frames obtained from the acoustic signal;

a first voice determination step of determining a first frame having the sound level greater than or equal to a first threshold value as a first target frame;

a spectrum shape feature calculation step of performing a process of calculating a feature value representing a spectrum shape for each of a plurality of second frames obtained from the acoustic signal;

a likelihood ratio calculation step of calculating a ratio of a likelihood of a voice model to a likelihood of a non-voice model for each of the plurality of second frames using the feature value as an input;

a second voice determination step of determining a second frame having the ratio greater than or equal to a second threshold value as a second target frame; and

an integration step of determining, in the acoustic signal, a section included in both a first target section corresponding to the first target frame and a second target section corresponding to the second target frame as a target voice section including a target voice.

According to the present invention, a program is provided. The program causes a computer to function as:

acoustic signal acquisition means for acquiring an acoustic signal; sound level calculation means for performing a process of calculating a sound level for each of a plurality of first frames obtained from the acoustic signal;

first voice determination means for determining a first frame having the sound level greater than or equal to a first threshold value as a first target frame;

spectrum shape feature calculation means for performing a process of calculating a feature value representing a spectrum shape for each of a plurality of second frames obtained from the acoustic signal;

likelihood ratio calculation means for calculating a ratio of a likelihood of a voice model to a likelihood of a non-voice model for each of the plurality of second frames using the feature value as an input;

second voice determination means for determining a second frame having the ratio greater than or equal to a second threshold value as a second target frame; and

integration means for determining, in acoustic signal, a section included in both a first target section corresponding to the first target frame and a second target section corresponding to the second target frame as a target voice section including a target voice.

### Advantageous Effects of Invention

The present invention enables a target voice section to be detected with high precision even in an environment in which various types of noise exist simultaneously.

### BRIEF DESCRIPTION OF DRAWINGS

The abovementioned object, other objects, features and advantages will become more apparent by use of the following preferred exemplary embodiments and the accompanying drawings.

FIG. 1 is a diagram conceptually illustrating a configuration example of a speech detection device according to a first exemplary embodiment.

FIG. 2 is a diagram illustrating a specific example of processing of extracting a plurality of frames from an acoustic signal.

FIG. 3 is a diagram illustrating a specific example of processing in an integration unit according to the first exemplary embodiment.

FIG. 4 is a flowchart illustrating an operation example of the speech detection device according to the first exemplary embodiment.

FIG. 5 is a diagram illustrating an effect of the speech detection device according to the first exemplary embodiment.

FIG. 6 is a diagram conceptually illustrating a configuration example of a speech detection device according to a second exemplary embodiment.

FIG. 7 is a diagram illustrating a specific example of first and second sectional shaping units according to the second exemplary embodiment.

FIG. 8 is a flowchart illustrating an operation example of the speech detection device according to the second exemplary embodiment.

FIG. 9 is a diagram illustrating a specific example of two types of voice determination results integrated after respectively undergoing sectional shaping.

FIG. 10 is a diagram illustrating a specific example of two types of voice determination results undergoing sectional shaping after being integrated.

FIG. 11 is a diagram illustrating a specific example of a time series of a sound level and a likelihood ratio under station announcement noise.

FIG. 12 is a diagram illustrating a specific example of a time series of a sound level and a likelihood ratio under door-opening/closing noise.

FIG. 13 is a diagram conceptually illustrating a configuration example of a speech detection device according to a modified example of the second exemplary embodiment.

FIG. 14 is a diagram conceptually illustrating a configuration example of a speech detection device according to a third exemplary embodiment.

FIG. 15 is a flowchart illustrating an operation example of the speech detection device according to the third exemplary embodiment.

FIG. 16 is a diagram illustrating a success example of voice detection based on likelihood ratio.

FIG. 17 is a diagram illustrating a success example of non-voice detection based on likelihood ratio.

FIG. 18 is a diagram illustrating a failure example of non-voice detection based on likelihood ratio.

FIG. 19 is a diagram conceptually illustrating a configuration example of a speech detection device according to a fourth exemplary embodiment.

FIG. 20 is a diagram conceptually illustrating an example of a hardware configuration of a speech detection device according to the present exemplary embodiments.

### DESCRIPTION OF EMBODIMENTS

First, an example of a hardware configuration of a speech detection device according to the present exemplary embodiments will be described.

The speech detection device according to the present exemplary embodiments may be a portable device or a stationary device. Each unit included in the speech detection device according to the present exemplary embodiments is implemented by use of any combination of hardware and software, in any computer, mainly including a central processing unit (CPU), a memory, a program (including a program downloaded from a storage medium such as a compact disc [CD], a server connected to the Internet, and the like, in addition to a program stored in a memory in advance from a device shipping stage) loaded into a memory, a storage unit, such as a hard disk, storing the program, and a network connection interface. It should be understood by those skilled in the art that various modified examples of the implementation method and the device may be available.

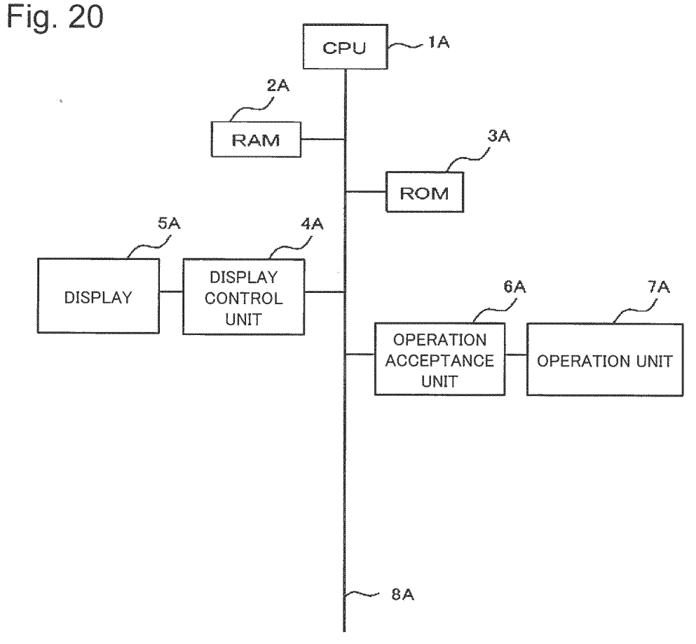

FIG. 20 is a diagram conceptually illustrating an example of a hardware configuration of the speech detection device according to the present exemplary embodiments. As illustrated, the speech detection device according to the present exemplary embodiments includes, for example, a CPU 1A, a random access memory (RAM) 2A, a read only memory (ROM) 3A, a display control unit 4A, a display 5A, an operation acceptance unit 6A, and an operation unit 7A, interconnected by a bus 8A. Although not being illustrated, the speech detection device according to the present exemplary embodiments may include an additional element such as an input/output I/F connected to an external apparatus in a wired manner, a communication unit for communicating with an external apparatus in a wired and/or wireless manner, a microphone, a speaker, a camera, and an auxiliary storage device.

The CPU 1A controls an entire computer in the electronic device along with each element. The ROM 3A includes an area storing a program for operating the computer, various application programs, various setting data used when those programs operate, and the like. The RAM 2A includes an area temporarily storing data, such as a work area for program operation.

The display 5A includes a display device (such as a light emitting diode [LED] indicator, a liquid crystal display, and an organic electro luminescence [EL] display). The display 5A may be a touch panel display integrated with a touch pad. The display control unit 4A reads data stored in a video RAM (VRAM), performs predetermined processing on the read data, and, subsequently transmits the data to the display 5A for various kinds of screen display. The operation acceptance unit 6A accepts various operations through the operation unit 7A. The operation unit 7A includes an operation key, an operation button, a switch, a jog dial, and a touch panel display.

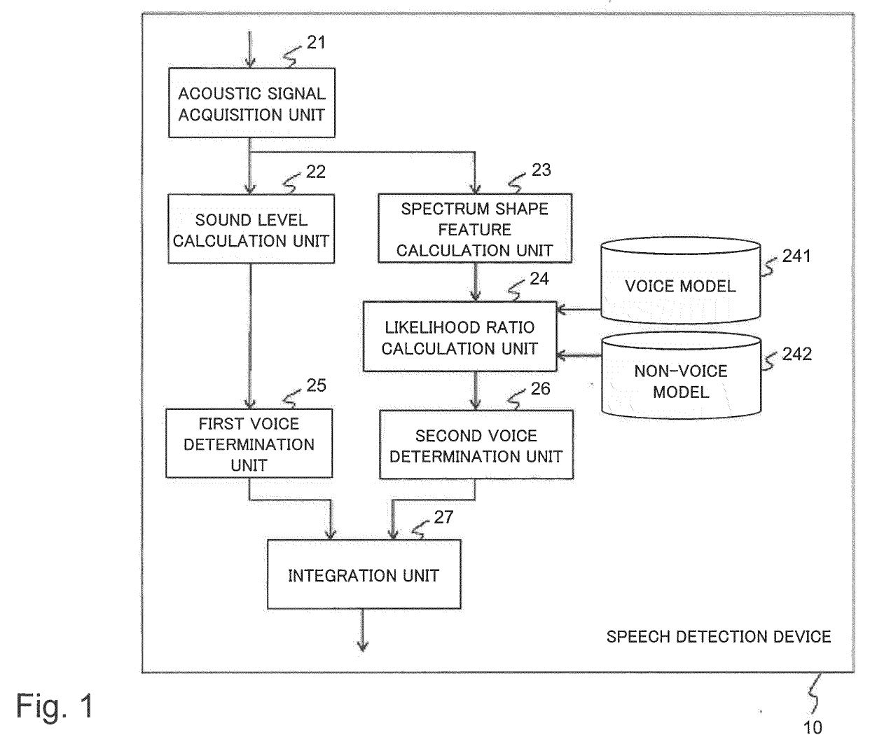

The present exemplary embodiments will be described below. Functional block diagrams (FIGS. 1, 6, 13, and 14) used in the following descriptions of the exemplary embodiments illustrate blocks on a functional basis instead of configurations on a hardware basis. Each device is described to be implemented by use of a single apparatus in the drawings. However, the implementation method is not limited thereto. In other words, each device may have a physically separated configuration or a logically separated configuration.

### First Exemplary Embodiment

[Processing Configuration]

FIG. 1 is a diagram conceptually illustrating a processing configuration example of a speech detection device according to a first exemplary embodiment. The speech detection device 10 according to the first exemplary embodiment includes an acoustic signal acquisition unit 21, a sound level calculation unit 22, a spectrum shape feature calculation unit 23, a likelihood ratio calculation unit 24, a voice model 241, a non-voice model 242, a first voice determination unit 25, a second voice determination unit 26, and an integration unit 27.

The acoustic signal acquisition unit 21 acquires an acoustic signal to be a processing target and extracts a plurality of frames from the acquired acoustic signal. The acoustic signal acquisition unit 21 may acquire an acoustic signal from a microphone attached to the speech detection device 10 in real time, or may acquire a prerecorded acoustic signal from a recording medium, an auxiliary storage device included in the speech detection device 10, or the like. Further, the acoustic signal acquisition unit 21 may acquire an acoustic signal from a computer other than the computer performing voice detection processing, via a network.

An acoustic signal is time-series data. A partial chunk in an acoustic signal is hereinafter referred to as “section.” Each section is specified/expressed by a section start point and a section end point. A section start point (start frame) and a section end point (end frame) of each section may be expressed by use of identification information (such as a serial number of a frame) of respective frames extracted (obtained) from an acoustic signal, by an elapsed time from the start point of an acoustic signal, or by another technique.

A time-series acoustic signal may be categorized into a section including detection target voice (hereinafter referred to as “target voice”) (hereinafter referred to as “target voice section”) and a section not including target voice (hereinafter referred to as “non-target voice section”). When an acoustic signal is observed in a chronological order, a target voice section and a non-target voice section appear alternately. An object of the speech detection device 10 according to the present exemplary embodiment is to specify a target voice section in an acoustic signal.

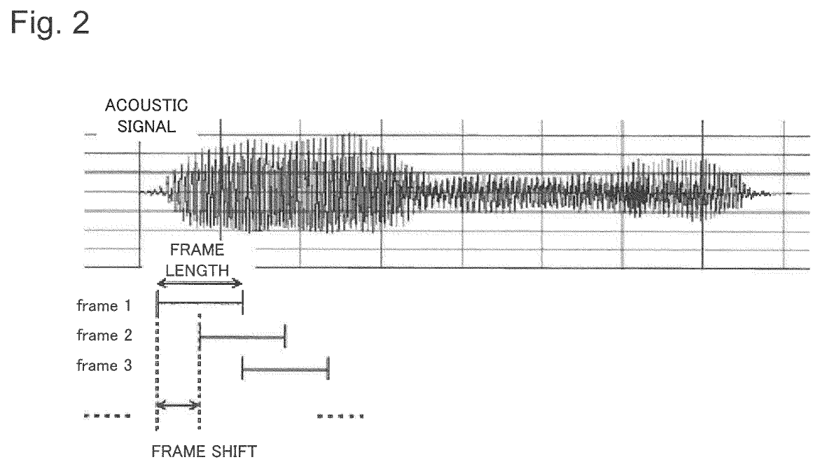

FIG. 2 is a diagram illustrating a specific example of processing of extracting a plurality of frames from an acoustic signal. A frame refers to a short time section in an acoustic signal. The acoustic signal acquisition unit 21 extracts a plurality of frames from an acoustic signal by sequentially shifting a section having a predetermined frame length by a predetermined frame shift length. Normally, adjacent frames are extracted so as to overlap one another. For example, the acoustic signal acquisition unit 21 may use 30 msec as a frame length and 10 msec as a frame shift length.

For each of a plurality of frames (first frames) extracted by the acoustic signal acquisition unit 21, the sound level calculation unit 22 performs a process of calculating a sound level of the first frame signal. The sound level calculation unit 22 may use an amplitude or power of the first frame signal, logarithmic values thereof, or the like as the sound level.

Alternatively, the sound level calculation unit 22 may take a ratio between a signal level and an estimated noise level in a first frame as the sound level of the signal. For example, the sound level calculation unit 22 may take a ratio between signal power and estimated noise power as the sound level of the first frame. By use of a ratio to an estimated noise level, the sound level calculation unit 22 is able to calculate a sound level robustly to variation of a microphone input level and the like. For estimation of a noise component in a first frame, the sound level calculation unit 22 may use, for example, a known technology such as PTL 1.

The first voice determination unit 25 compares a sound level calculated for each first frame by the sound level calculation unit 22 with a predetermined threshold value. Then, the first voice determination unit 25 determines a first frame having a sound level greater than or equal to the threshold value (first threshold value) as a frame including target voice (first target frame), and determines a first frame having a sound level less than the first threshold value as a frame not including target voice (first non-target claim). The first threshold value may be determined by use of an acoustic signal being a processing target. For example, the first voice determination unit 25 may calculate respective sound levels of a plurality of first frames extracted from an acoustic signal being a processing target, and take a value calculated in accordance with a predetermined operation using the calculation result (such as a mean value, a median value, and a boundary value separating the top X % from the bottom [100-X] %) as the first threshold value.

For each of a plurality of frames (second frames) extracted by the acoustic signal acquisition unit 21, the spectrum shape feature calculation unit 23 performs a process of calculating a feature value representing a frequency spectrum shape of the second frame signal. The spectrum shape feature calculation unit 23 may use known feature values commonly used in an acoustic model in speech recognition such as a mel-frequency cepstrum coefficient (MFCC), a linear prediction coefficient (LPC coefficient), a perceptive linear prediction coefficient (PLP coefficient), and time difference (A, AA) of the coefficients, as a feature value representing a frequency spectrum shape. Such feature values are also known to be effective for classification of voice and non-voice.

The likelihood ratio calculation unit 24 calculates A being a ratio of a likelihood of a voice model 241 to a likelihood of a non-voice model 242 (may hereinafter simply referred to as “likelihood ratio” or “voice-to-non-voice likelihood ratio”), with a feature value calculated for each second frame by the spectrum shape feature calculation unit 23 as an input. The likelihood ratio A is calculated by an equation expressed by equation 1.

$$Λ = \frac{p ( {x}_{t} \vert {Θ}_{s} )}{p ( {x}_{t} \vert {Θ}_{n} )} \qquad [ Equation 1 ]$$

Note that xt denotes an input feature value, 0s denotes a voice model parameter, and On denotes a non-voice model parameter. The likelihood ratio may be calculated as a log-likelihood ratio.

The voice model 241 and the non-voice model 242 are learned in advance by use of a learning acoustic signal in which a voice section and a non-voice section are labeled. It is preferable that much noise assumed in an environment to which the speech detection device 10 is applied is included in a non-voice section of the learning acoustic signal. As a model, for example, a Gaussian mixture model (GMM) is used. A model parameter may be learned by use of maximum likelihood estimation.

The second voice determination unit 26 compares a likelihood ratio calculated by the likelihood ratio calculation unit 24 with a predetermined threshold value (second threshold value). Then, the second voice determination unit 26 determines a second frame having a likelihood ratio greater than or equal to the second threshold value as a frame including target voice (second target frame), and determines a second frame having a likelihood ratio less than the second threshold value as a frame not including target voice (second non-target frame).

The acoustic signal acquisition unit 21 may extract a first frame processed by the sound level calculation unit 22 and a second frame processed by the spectrum shape feature calculation unit 23 with a same frame length and a same frame shift length. Alternatively, the acoustic signal acquisition unit 21 may separately extract a first frame and a second frame by use of a different value for at least one of a frame length and a frame shift length. For example, the acoustic signal acquisition unit 21 may extract a first frame by use of 100 msec as a frame length and 20 msec as a frame shift length, and extract a second frame by use of 30 msec as a frame length and 10 msec as a frame shift length. Thus, the acoustic signal acquisition unit 21 is able to use an optimum frame length and frame shift length for the sound level calculation unit 22 and the spectrum shape feature calculation unit 23, respectively.

The coupling unit 27 determines a section included in both a first target section corresponding to a first target frame in an acoustic signal and a second target section corresponding to a second target frame as a target voice section including target voice. In other words, the coupling unit 27 determines a section determined to include target voice by both the first voice determination unit 25 and the second voice determination unit 26 as a section including target voice to be detected (target voice section).

The integration unit 27 specifies a section corresponding to a first target frame and a section corresponding to a second target frame by use of a mutually comparable expression (criterion). Then, the integration unit 27 specifies a target voice section included in both.

For example, when a frame length and a frame shift length of a first frame and a second frame are the same, the integration unit 27 may specify a first target section and a second target section by use of identification information of a frame. In this case, for example, first target sections are expressed by frame numbers 6 to 9, 12 to 19, . . . , and second target sections are expressed by frame numbers 5 to 7, 11 to 19, . . . . Then, the integration unit 27 specifies a frame included in both a first target section and a second target section. When first target sections and second target sections are expressed by the example above, the target voice sections are expressed by frame numbers 6 and 7, 12 to 19, . . . .

In addition, the integration unit 27 may specify a section corresponding to a first target frame and a section corresponding to a second target frame by use of an elapsed time from the start point of an acoustic signal. In this case, the integration unit 27 needs to express respective sections corresponding to a first target frame and a second target frame by an elapsed time from the start point of the acoustic signal. An example of expressing a section corresponding to each frame by an elapsed time from the start point of an acoustic signal will be described.

A section corresponding to each frame is at least part of a section extracted from an acoustic signal by the each frame. As described by use of FIG. 2, a plurality of frames (first and second frames) may be extracted so as to overlap with adjacent frames. In such a case, a section corresponding to each frame is part of a section extracted by the each frame. Which of the sections extracted by each frame is to be taken as a corresponding section is a design matter. For example, in case of a frame length 30 msec and a frame shift length 10 msec, a frame extracting a 0 (start point) to 30 msec part in an acoustic signal, a frame extracting a 10 msec to 40 msec part, a frame extracting a 20 msec to 50 msec part, and the like exist. In this case, the integration unit 27 may, for example, take 0 to 10 msec in the acoustic signal as a section corresponding to the frame extracting the 0 (start point) to 30 msec part, 10 msec to 20 msec in the acoustic signal as a section corresponding to the frame extracting the 10 msec to 40 msec part, and 20 msec to 30 msec in the acoustic signal as a section corresponding to the frame extracting the 20 msec to 50 msec part. Thus, a section corresponding to a given frame does not overlap with a section corresponding to another frame. When a plurality of frames (first and second frames) are extracted so as not to overlap with adjacent frames, the integration unit 27 is able to take an entire part extracted by each frame as a section corresponding to the each frame.

By use of, for example, the technique described above, the integration unit 27 expresses sections corresponding to a first target frame and a second target frame by use of an elapsed time from the start point of an acoustic signal. Then, the integration unit 27 specifies a time period included in both as a target voice section.

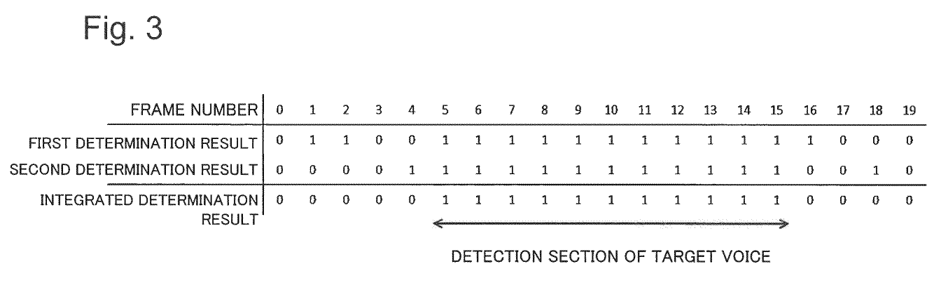

An example will be described by use of FIG. 3. In the case of the example in FIG. 3, a first frame and a second frame are extracted with a same frame length and a same frame shift length. In FIG. 3, a frame determined to include target voice is represented by “1” and a frame determined not to include target voice (non-voice) is represented by “0.” In the drawing, a “first determination result” is a determination result of the first voice determination unit 25 and a “second determination result” is a determination result of the second voice determination unit 26. Further, an “integrated determination result” is a determination result of the integration unit 27. As can be seen from the drawing, the integration unit 27 determines a section corresponding to frames for which both first determination results based on the first voice determination unit 25 and second determination results based on the second voice determination unit 26 are “1,” that is, frames having frame numbers 5 to 15, as a section including target voice (target voice section).

The speech detection device 10 according to the first exemplary embodiment outputs a section determined as a target voice section by the integration unit 27 as a voice detection result. The voice detection result may be expressed by a frame number, by an elapsed time from the head of an input acoustic signal, or the like. For example, when a frame shift length in FIG. 3 is 10 msec, the speech detection device 10 may also express the detected target voice section as 50 msec to 160 msec.

[Operation Example]

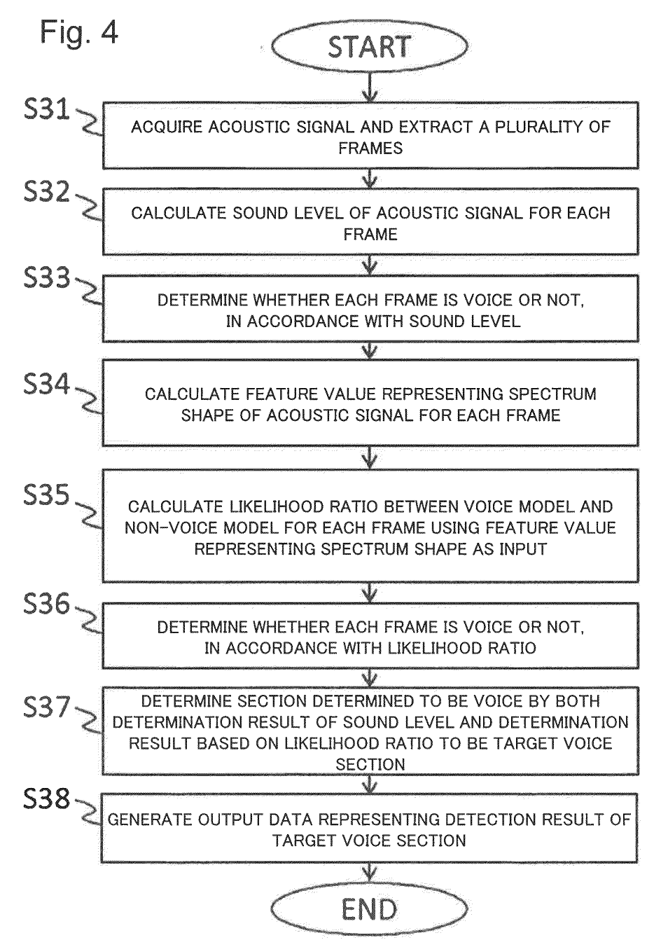

A speech detection method according to the first exemplary embodiment will be described below by use of FIG. 4. FIG. 4 is a flowchart illustrating an operation example of the speech detection device 10 according to the first exemplary embodiment.

The speech detection device 10 acquires an acoustic signal being a processing target and extracts a plurality of frames from the acoustic signal (S31). The speech detection device 10 may acquire an acoustic signal from a microphone attached to the apparatus in real time, acquire acoustic data prerecorded in a storage device medium or the speech detection device 10, or acquire an acoustic signal from another computer via a network.

Next, for each frame extracted in S31, the speech detection device 10 performs a process of calculating a sound level of the signal of the frame (S32).

Subsequently, the speech detection device 10 compares the sound level calculated in S32 with a predetermined threshold value, and determines a frame having a sound level greater than or equal to the threshold value as a frame including target voice and determines a frame having a sound level less than the threshold value as a frame not including target voice (S33).

Next, for each frame extracted in S31, the speech detection device 10 performs a process of calculating a feature value representing a frequency spectrum shape of the signal of the frame (S34).

Subsequently, the speech detection device 10 performs a process of calculating a ratio of a likelihood of a voice model to a likelihood of a voice model for each frame with a feature value calculated in S34 as an input (S35). The voice model 241 and the non-voice model 242 are created in advance, in accordance with learning by use of a learning acoustic signal.

Subsequently, the speech detection device 10 compares the likelihood ratio calculated in S35 with a predetermined threshold value, and determines a frame having a likelihood ratio greater than or equal to the threshold value as a frame including target voice and determines a frame having a likelihood ratio less than the threshold value as a frame not including target voice (S36).

Next, the speech detection device 10 determines a section included in both a section corresponding to a frame determined to include target voice in S33 and a section corresponding to a frame determined to include target voice in S36 as a section including target voice to be detected (target voice section) (S37).

Subsequently, the speech detection device 10 generates output data representing a detection result of the target voice section determined in S37 (S38). The output data may be data to be output to another application using a voice detection result such as speech recognition, noise tolerance processing, and coding processing, or data to be displayed on a display and the like.

The operation of the speech detection device 10 is not limited to the operation example in FIG. 4. For example, a set of processing steps in S32 and S33 and a set of processing steps in S34 to S36 may be performed in a reverse order. These sets of processing steps may be performed simultaneously in parallel. Further, in a case of processing an acoustic signal input in real time or the like, the speech detection device 10 may perform each of the processing steps in S31 to S37 repeatedly on a frame-by-frame basis. For example, the speech detection device 10 may operate to extract a single frame from an input acoustic signal in S31, process only an extracted single frame in S32 and S33 and S34 to S36, process only a frame for which determination is complete in S33 and S36 in S37, and repeatedly perform S31 to S37 until processing of the entire input acoustic signal is complete.

### Operations and Effects of First Exemplary Embodiment

As described above, the first exemplary embodiment detects a section in which a sound level is greater than or equal to a predetermined threshold value and a ratio of a likelihood of a voice model to a likelihood of a non-voice model, with a feature value representing a frequency spectrum shape as an input, is greater than or equal to a predetermined threshold value as a target voice section. Therefore, the first exemplary embodiment is able to detect a target voice section with high precision even in an environment in which various types of noise exist simultaneously.

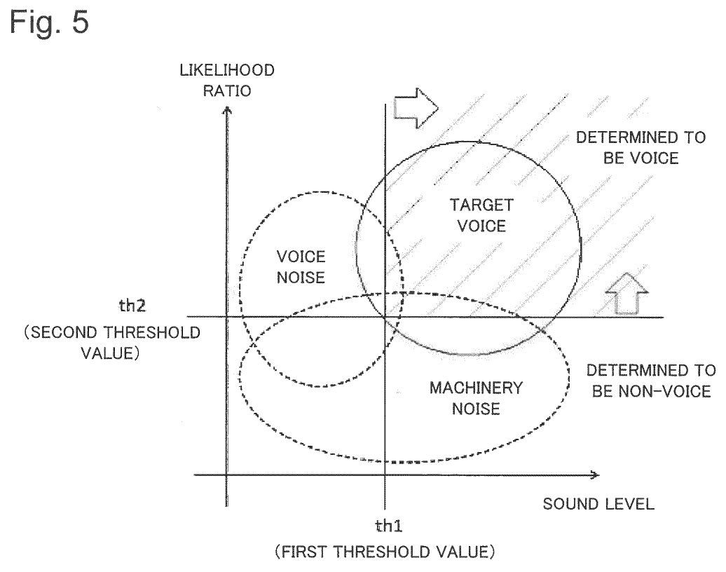

FIG. 5 is a diagram illustrating a mechanism that enables the speech detection device 10 according to the first exemplary embodiment to correctly detect target voice even when various types of noise exist simultaneously. FIG. 5 is a diagram arranging target voice to be detected and noise not to be detected in a space expressed by two axis being “sound level” and “likelihood ratio.” “Target voice” to be detected is generated at a location close to a microphone and therefore has a high sound level, and further is human voice and therefore has a high likelihood ratio.

As a result of analyzing background noise in various situations to which a voice detection technology is applied, the present inventors discovered that various types of noise can be roughly classified into two types being “voice noise” and “machinery noise,” and both noise types are distributed in an L shape in a “sound level”-and-“likelihood ratio” space as illustrated in FIG. 5.

As described above, voice noise is noise including human voice. For example, voice noise includes voice in a conversation by people around, announcement voice in station premises and voice generated by a TV. In most of situations to which a voice detection technology is applied, these types of voice are not preferred to be detected. Voice noise is human voice, and therefore the voice-to-non-voice likelihood ratio is high. Consequently, the likelihood ratio is not able to distinguish between voice noise and target voice to be detected. By contrast, voice noise is generated at a location distant from a microphone, and therefore a sound level is low. In FIG. 5, voice noise largely exists in a domain in which a sound level is less than a first threshold value thl. Consequently, voice noise may be rejected by determining a signal as target voice when a sound level is greater than or equal to the first threshold value.

Machinery noise is noise not including human voice. For example, machinery noise includes a road work sound, a car traveling sound, a door-opening/closing sound, and a keying sound. A sound level of machinery noise may be high or low. In some cases, machinery noise may be louder than or as loud as target voice to be detected. Thus, machinery noise and target voice cannot be distinguished by sound level. Meanwhile, when machinery noise is properly learned as a non-voice model, the voice-to-non-voice likelihood ratio of machinery noise is low. In FIG. 5, machinery noise largely exists in a domain in which the likelihood ratio is less than a second threshold value th2. Consequently, machinery noise may be rejected by determining a signal as target voice when the likelihood ratio is greater than or equal to a predetermined threshold value.

In the speech detection device 10 according to the first exemplary embodiment, the sound level calculation unit 22 and the first voice determination unit 25 operate to reject noise having a low sound level, that is, voice noise. Further, the spectrum shape feature calculation unit 23, the likelihood ratio calculation unit 24, and the second voice determination unit 26 operate to reject noise having a low likelihood ratio, that is, machinery noise. Then, the integration unit 27 detects a section determined to include target voice by both the first voice determination unit and the second voice determination unit as a target voice section. Therefore, the speech detection device 10 is able to detect a target voice section only, with high precision, even in an environment in which voice noise and machinery noise exist simultaneously, without erroneously detecting either of the noise types.

### Second Exemplary Embodiment

A speech detection device according to a second exemplary embodiment will be described below focusing on difference from the first exemplary embodiment. Content similar to the first exemplary embodiment is omitted as appropriate in the description below.

[Processing Configuration]

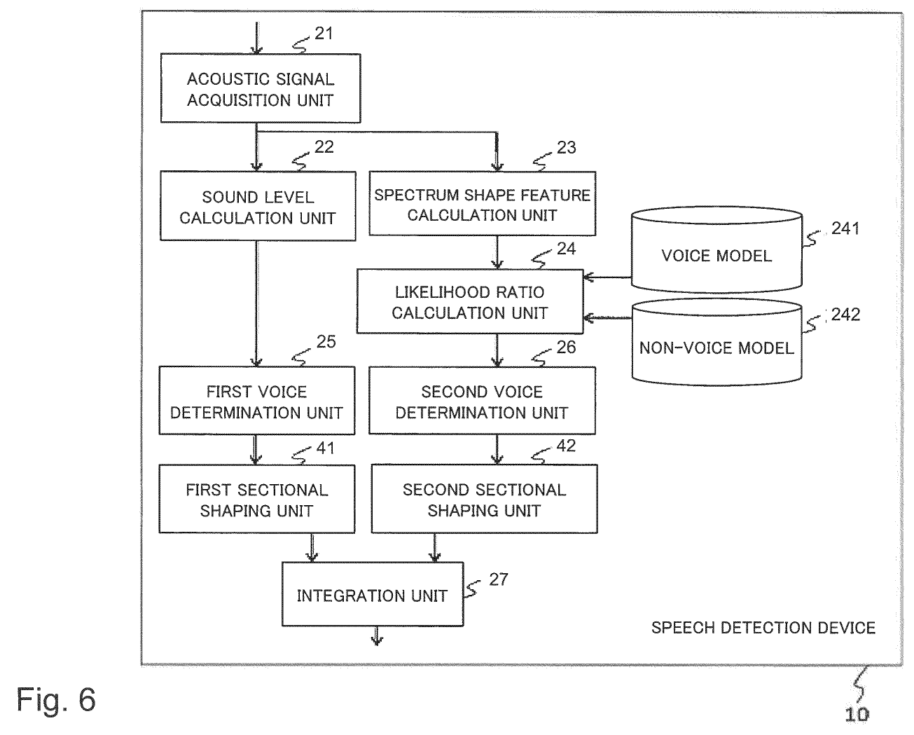

FIG. 6 is a diagram conceptually illustrating a processing configuration example of the speech detection device 10 according to the second exemplary embodiment. The speech detection device 10 according to the second exemplary embodiment further includes a first sectional shaping unit 41 and a second sectional shaping unit 42, in addition to the configuration of the first exemplary embodiment.

The first sectional shaping unit 41 determines whether each frame is voice or not by performing a shaping process on a determination result of the first voice determination unit 25 to eliminate a target voice section shorter than a predetermined value and a non-voice section shorter than a predetermined value.

For example, the first sectional shaping unit 41 performs at least one of the following two types of shaping processes on a determination result of the first voice determination unit 25. Then, after performing the shaping process, the first sectional shaping unit 41 inputs the determination result after the shaping process to the integration unit 27.

“A shaping process of, out of a plurality of first target sections (sections corresponding to first target frames determined to include target voice by the first voice determination unit 25) separated from one another in an acoustic signal, changing a first target frame corresponding to a first target section having a length less than a predetermined value to a first frame not being a first target frame.”

“A shaping process of, out of a plurality of first non-target sections (sections corresponding to a first target frame determined not to include target voice by the first voice determination unit 25) separated from one another in an acoustic signal, changing a first frame corresponding to a first non-target section having a length less than a predetermined value to a first target frame.”

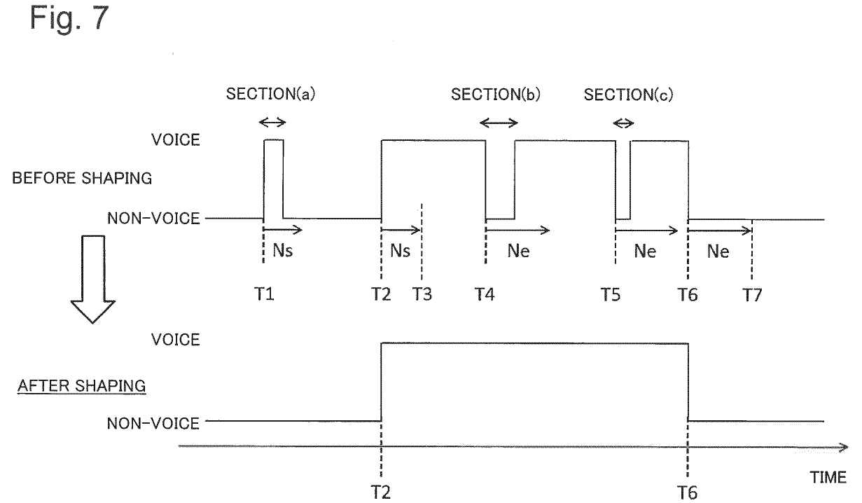

FIG. 7 is a diagram illustrating a specific example of a shaping process of changing a first target section having a length less than Ns sec to a first non-target section, and a shaping process of changing a first non-target section having a length less than Ne sec to a first target section, respectively by the first sectional shaping unit 41. The length may be measured in a unit other than seconds such as a number of frames.

The upper row in FIG. 7 illustrates a voice detection result before shaping, that is, an output of the first voice determination unit 25. The lower row in FIG. 7 illustrates a voice detection result after shaping. The upper row in FIG. 7 illustrates that target voice is determined to be included at a time T1. However, the length of a section (a) determined to continuously include target voice is less than Ns sec. Therefore, the first target section (a) is changed to a first non-target section (refer to the lower row in FIG. 7). Meanwhile, the upper row in FIG. 7 illustrates that a first target section starting at a time T2 has a length greater than or equal to Ns sec, and therefore is not changed to a first non-target section, and remains as a first target section (refer to the lower row in FIG. 7). In other words, the first sectional shaping unit 41 determines the time T2 as a starting end of a voice detection section (first target section) at a time T3.

The upper row in FIG. 7 illustrates determination of non-voice at a time T4. However, a length of a section (b) determined as continuously non-voice is less than Ne sec. Therefore, the first non-target section (b) is changed to a first target section (refer to the lower row in FIG. 7). Further, the upper row in FIG. 7 illustrates a length of a first non-target section (c) starting at a time T5 is also less than Ne sec. Therefore, the first non-target section (c) is also changed to a first target section (refer to the lower row in FIG. 7). Meanwhile, the upper row in FIG. 7 illustrates that a first non-target section starting at a time T6 has a length greater than or equal to Ne sec, and therefore is not changed to a first target section, and remains as a first non-target section (refer to the lower row in FIG. 7). In other words, the first sectional shaping unit 41 determines the time T6 as a finishing end of the voice detection section (first target section) at a time T7.

The parameters Ns and Ne for shaping are preset to appropriate values, in accordance with an evaluation experiment or the like using development data.

The voice detection result in the upper row in FIG. 7 is shaped to the voice detection result in the lower row, in accordance with the shaping process described above. A shaping process of a voice detection section is not limited to the procedures described above. For example, processing of eliminating a voice section having a length less than or equal to a certain length on a section obtained through the procedures described above may be added to the shaping process of a voice detection section, or another method may be used for shaping a voice detection section.

The second sectional shaping unit 42 determines whether each frame is voice or not by performing a shaping process on a determination result of the second voice determination unit 26 to eliminate a voice section shorter than a predetermined value and a non-voice section shorter than a predetermined value.

For example, the second sectional shaping unit 42 performs at least one of the following two types of shaping processes on a determination result of the second voice determination unit 26. Then, after performing the shaping process, the second sectional shaping unit 42 inputs the determination result after the shaping process to the integration unit 27.

“A shaping process of, out of a plurality of second target sections (sections corresponding to second target frames determined to include target voice by the second voice determination unit 26) separated from one another in an acoustic signal, changing a second target frame corresponding to a second target section having a length shorter than a predetermined value to a second frame not being a second target frame.”

“A shaping process of, out of a plurality of second non-target sections (sections corresponding to second target frames determined not to include target voice by the second voice determination unit 26) separated from one another in an acoustic signal, changing a second frame corresponding to a second non-target section having a length shorter than a predetermined value to a second target frame.”

Processing details of the second sectional shaping unit 42 are the same as the first sectional shaping unit 41 except that an input is a determination result of the second voice determination unit 26 instead of a determination result of the first voice determination unit 25. Parameters used for shaping such as Ns and Ne in the example in FIG. 7 may be different between the first sectional shaping unit 41 and the second sectional shaping unit 42.

The integration unit 27 determines a target voice section by use of determination results after the shaping process input from the first sectional shaping unit 41 and the second sectional shaping unit 42. In other words, the integration unit 27 determines a section determined to include target voice by both the first sectional shaping unit 41 and the second sectional shaping unit 42 as a target voice section. In other words, processing details of the integration unit 27 according to the second exemplary embodiment are the same as the integration unit 27 according to the first exemplary embodiment except that inputs are determination results of the first sectional shaping unit 41 and the second sectional shaping unit 42 instead of determination results of the first voice determination unit 25 and the second voice determination unit 26.

The speech detection device 10 according to the second exemplary embodiment outputs a section determined as target voice by the integration unit 27, as a voice detection result.

[Operation Example]

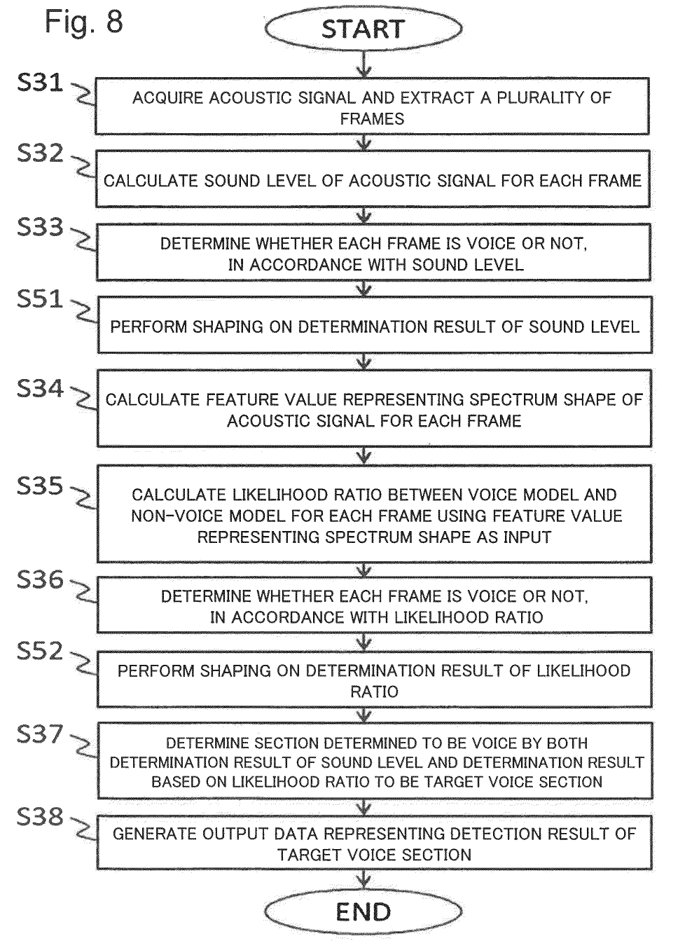

A speech detection method according to the second exemplary embodiment will be described below by use of FIG. 8. FIG. 8 is a flowchart illustrating an operation example of the speech detection device according to the second exemplary embodiment. In FIG. 8, a same reference sign as FIG. 4 is given to a same step indicated in FIG. 4. Description of a same step is omitted.

In S51, the speech detection device 10 determines whether each first frame includes target voice or not by performing a shaping process on a determination result of sound level in S33.

In S52, the speech detection device 10 determines whether each second frame includes target voice or not by performing a shaping process on a determination result of likelihood ratio in S36.

The speech detection device 10 determines a section included in both a section specified by a first frame determined to include target voice in S51 and a section specified by a second frame determined to include target voice in S52 as a section including target voice to be detected (target voice section) (S37).

The operation of the speech detection device 10 is not limited to the operation example in FIG. 8. For example, a set of processing steps in S32 to S51 and a set of processing steps in S34 to S52 may be performed in a reverse order. These sets of processing may be performed simultaneously in parallel. Further, in a case of processing an acoustic signal input in real time or the like, the speech detection device 10 may perform each of the processing steps in S31 to S37 repeatedly on a frame-by-frame basis. In this case, in order to determine whether a frame is voice or non-voice, the shaping process in S51 and S52 requires determination results in S33 and S36 with respect to several frames after the frame in question. Consequently, determination results in S51 and S52 are output with delay from real time by a number of frames required for determination. Processing in S37 may operate to be performed on a section for which determination results in S51 and S52 are obtained.

### Operations and Effects of Second Exemplary Embodiment

As described above, the second exemplary embodiment performs a shaping process on a voice detection result of sound level, performs a different type of shaping processes on a voice detection result of likelihood ratio, and, subsequently, detects a section determined to include target voice in both of the shaping results as a target voice section. Therefore, the second exemplary embodiment is able to detect a target voice section with high precision even in an environment in which various types of noise exist simultaneously, and also is able to prevent a voice detection section from being fragmented due to a short gap such as breathing during an utterance.

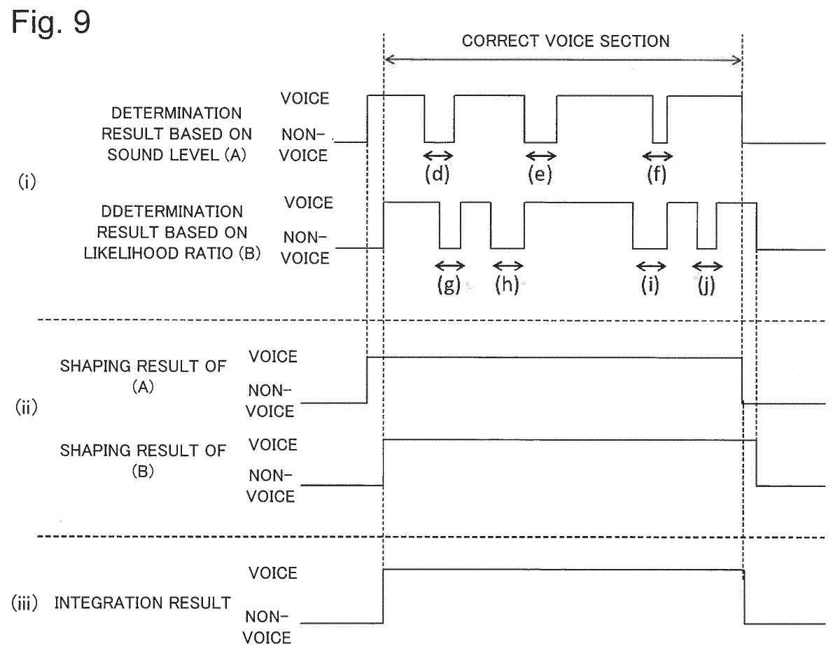

FIG. 9 is a diagram describing a mechanism that enables the speech detection device 10 according to the second exemplary embodiment to prevent a voice detection section from being fragmented. FIG. 9 is a diagram schematically illustrating outputs of the respective units in the speech detection device 10 according to the second exemplary embodiment when an utterance to be detected is input.

A “determination result of sound level (A)” in FIG. 9 illustrates a determination result of the first voice determination unit 25 and a “determination result of likelihood ratio (B)” illustrates a determination result of the second voice determination unit 26. As illustrated in the drawing, even in a continuous utterance, the determination result of sound level (A) and the determination result of likelihood ratio (B) are often composed of a plurality of first and second target sections (voice sections) and first and second non-target sections (non-voice sections), separated from one another. For example, even in a continuous utterance, a sound level constantly fluctuates. A partial drop of several tens of milliseconds to several hundreds of milliseconds in sound level is often observed. Further, even in a continuous utterance, a partial drop of several tens of milliseconds to several hundreds of milliseconds in likelihood ratio at a phoneme boundary and the like is also often observed. Furthermore, a position of a section determined to include target voice is mostly different between the determination result of sound level (A) and the determination result of likelihood ratio (B). The reason is that the sound level and the likelihood ratio respectively capture different features of an acoustic signal.

A “shaping result of (A)” in FIG. 9 illustrates a shaping result of the first sectional shaping unit 41. A “shaping result of (B)” illustrates a shaping result of the second sectional shaping unit 42. In accordance with the shaping process, first non-target sections (non-voice sections) (d) to (f) in the determination result of sound level and short second non-target sections (non-voice sections) (g) to (j) in the determination result of likelihood ratio are changed to target voice sections (voice sections). One first and one second target voice sections are obtained in the respective results.

An “integration result” in FIG. 9 illustrates a determination result of the integration unit 27. The short first and second non-target sections (non-voice sections) are eliminated (changed to first and second target voice sections) by the first sectional shaping unit 41 and the second sectional shaping unit 42, and therefore one utterance section is correctly detected as an integration result.

The speech detection device 10 according to the second exemplary embodiment operates as described above, and therefore prevents an utterance section to be detected from being fragmented.

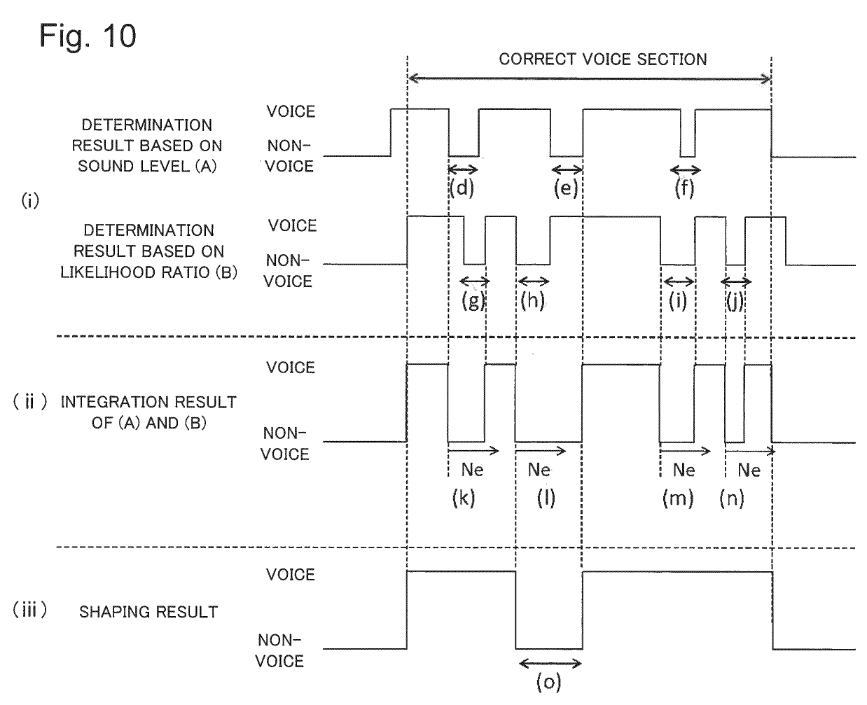

Such an effect is an effect obtained precisely because the device is so configured as to perform a sectional shaping process independently on a determination result of sound level and a determination result of likelihood ratio, respectively, and subsequently integrate the results. FIG. 10 is a diagram schematically illustrating outputs of the respective units when the speech detection device 10 according to the first exemplary embodiment is applied to the same input signal as FIG. 9, and a shaping process is performed on a determination result of the integration unit 27 according to the first exemplary embodiment. An “integration result of (A) and (B)” in FIG. 10 illustrates a determination result of the integration unit 27 according to the first exemplary embodiment. A “shaping result” illustrates a result of performing a shaping process on the obtained determination result. As described above, a position of a section determined to include target voice is different between the determination result of voice (A) and the determination result of likelihood ratio (B). Consequently, a long non-voice section may appear in the integration result of (A) and (B). A section (1) in FIG. 10 represents such a long non-voice section. The length of the section (1) is longer than a parameter Ne of the shaping process. Thus, the non-voice section is not eliminated (changed to a target voice section) in accordance with the shaping process, and remains as a non-voice section (o). In other words, when the shaping process is performed on a result of the integration unit 27, even in a continuous utterance section, a voice section to be detected tends to be fragmented.

Before integrating the two types of determination results, the speech detection device 10 according to the second exemplary embodiment performs a sectional shaping process on the respective determination results, and therefore is able to detect a continuous utterance section as one voice section without the section being fragmented.

As described above, operation without interrupting a voice detection section in the middle of an utterance is particularly effective in a case such as applying speech recognition to a detected voice section. For example, in an apparatus operation using speech recognition, when a voice detection section is interrupted in the middle of an utterance, speech recognition cannot be performed on the entire utterance, and therefore details of the apparatus operation are not correctly recognized. Further, in a spoken language, hesitation phenomena being interruption of an utterance occur frequently. When a detection section is fragmented by hesitations, precision of speech recognition tends to decrease.

Specific examples of voice detection under voice noise and machinery noise will be described below.

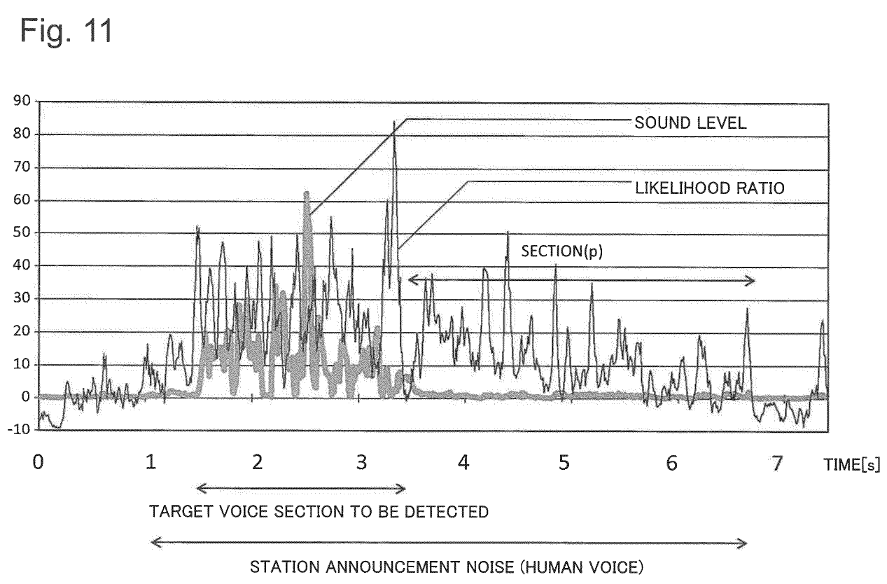

FIG. 11 illustrates time series of a sound level and a likelihood ratio when a continuous utterance is performed under station announcement noise. A section from 1.4 to 3.4 sec represents a target voice section to be detected. The station announcement noise is voice noise. Consequently, a large value of the likelihood ratio continues in a section (p) after the utterance is complete. By contrast, the sound level in the section (p) has a small value. Therefore, the section (p) is correctly determined as non-voice by the speech detection device 10 according to the first and second exemplary embodiments. Additionally, in the target voice section to be detected (from 1.4 to 3.4 sec), the sound level and the likelihood ratio repeatedly fluctuate with varying magnitudes at varying positions. However, even in such a case, the speech detection device 10 according to the second exemplary embodiment is able to correctly detect the target voice section to be detected as one voice section without interrupting the utterance section.

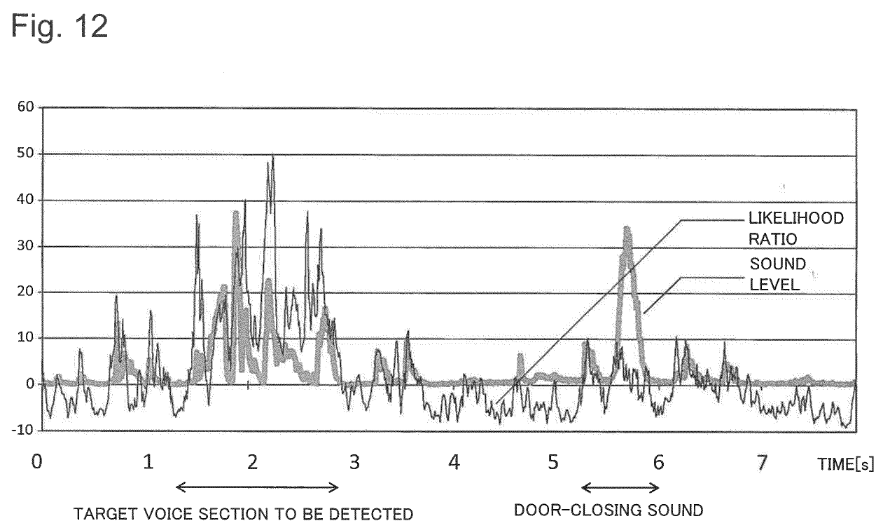

FIG. 12 illustrates time series of a sound level and a likelihood ratio when a continuous utterance is performed in the presence of a door-closing sound (from 5.5 to 5.9 sec). A section from 1.3 to 2.9 sec is a target voice section to be detected. The door-closing sound is machinery noise. In this case, the sound level of the door-closing sound has a higher value than the target voice section. By contrast, the likelihood ratio of the door-closing sound has a small value. Therefore, the door-closing sound is correctly determined as non-voice by the speech detection device 10 according to the first and second exemplary embodiments. Additionally, in the target voice section to be detected (from 1.3 to 2.9 sec), the sound level and the likelihood ratio repeatedly fluctuate with varying magnitudes at varying positions. However, even in such a case, the speech detection device 10 according to the second exemplary embodiment is able to correctly detect the target voice section to be detected as one voice section. Thus, the speech detection device 10 according to the second exemplary embodiment is confirmed to be effective in various real-world noise environments.

### Modified Example of Second Exemplary Embodiment

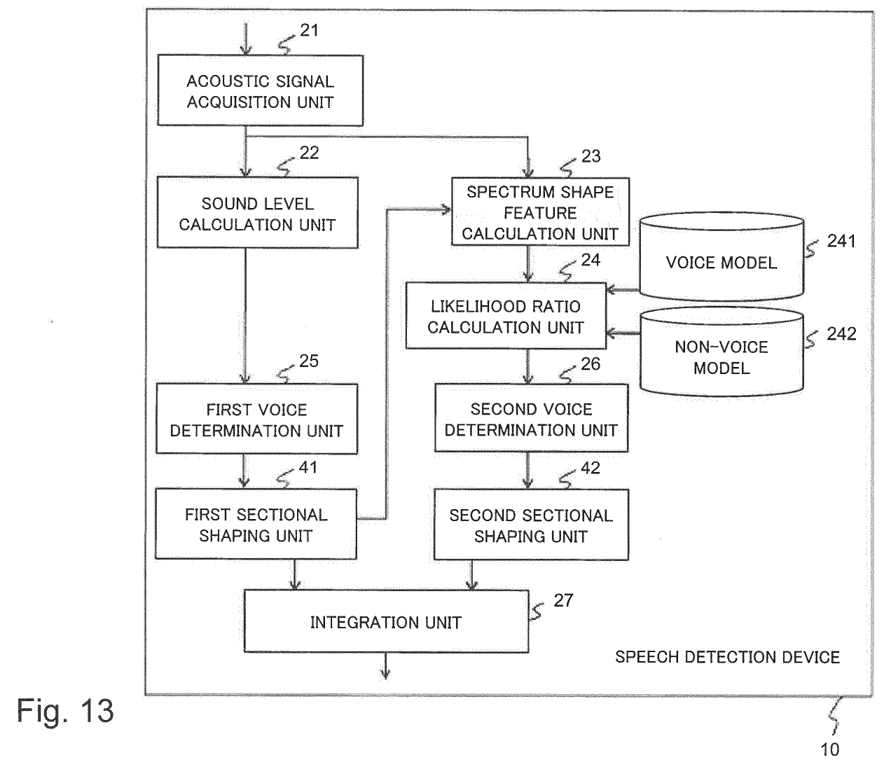

FIG. 13 is a diagram conceptually illustrating a processing configuration example of a speech detection device 10 according to a modified example of the second exemplary embodiment. The configuration of the present modified example is the same as the configuration of the second exemplary embodiment except that the spectrum shape feature calculation unit 23 calculates a feature value only for an acoustic signal in a section determined to include target voice by the first sectional shaping unit 41 (section specified by a first target frame after the shaping process based on the first sectional shaping unit 41). The likelihood ratio calculation unit 24, the second voice determination unit 26, and the second sectional shaping unit perform a process only on a frame for which a feature value is calculated by the spectrum shape feature calculation unit 23 as a target.

The spectrum shape feature calculation unit 23, the likelihood ratio calculation unit 24, the second voice determination unit 26, and the second sectional shaping unit 42 according to the present modified example operate only on a section determined to include target voice by the first sectional shaping unit 41. Consequently, the present modified example is able to greatly reduce a calculation amount. The integration unit 27 determines only a section determined to include target voice at least by the first sectional shaping unit 41 as a target voice section. Therefore, the present modified example is able to reduce a calculation amount while outputting a same detection result.

### Third Exemplary Embodiment

A speech detection device 10 according to a third exemplary embodiment will be described below focusing on difference from the first exemplary embodiment. Content similar to the first exemplary embodiment is omitted as appropriate in the description below.

[Processing Configuration]

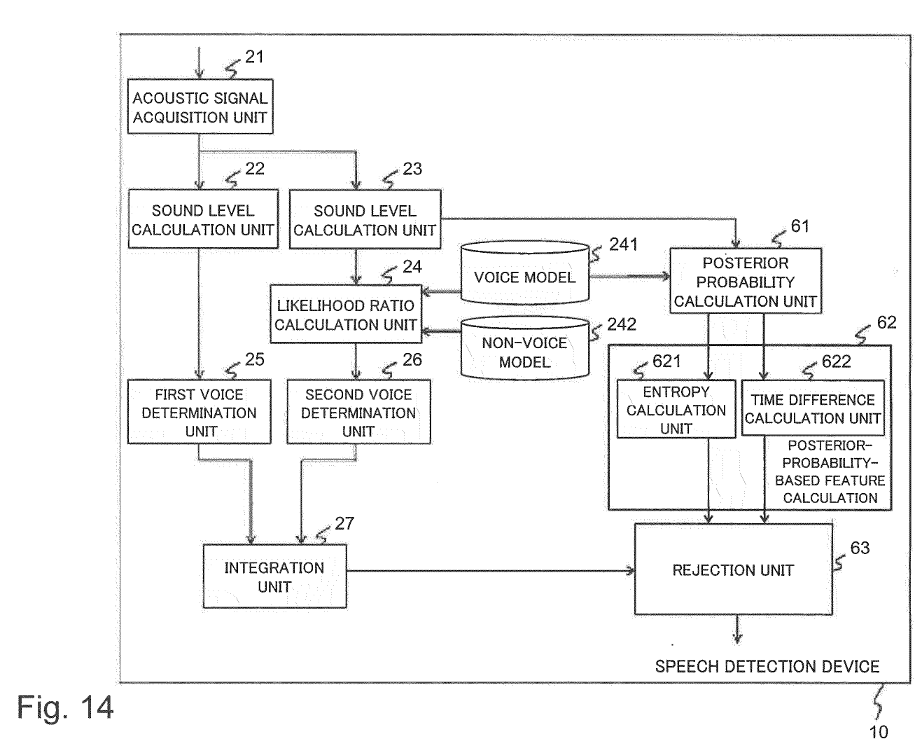

FIG. 14 is a diagram conceptually illustrating a processing configuration example of the speech detection device 10 according to the third exemplary embodiment. The speech detection device 10 according to the third exemplary embodiment further includes a posterior probability calculation unit 61, a posterior-probability-based feature calculation unit 62, and a rejection unit 63 in addition to the configuration of the first exemplary embodiment.

With a feature value calculated by the spectrum shape feature calculation unit 23 from each of a plurality of frames (third frames) extracted by the acoustic signal acquisition unit 21 as an input, the posterior probability calculation unit 61 calculates the posterior probability p(qk|xt) for a plurality of phonemes by use of the voice model 241 for each third frame. Note that xt denotes a feature value at a time t and qk denotes a phoneme k. In FIG. 14, a voice model used by the likelihood ratio calculation unit 24 and a voice model used by the posterior probability calculation unit 61 are common. However, the likelihood ratio calculation unit 24 and the posterior probability calculation unit 61 may respectively use different voice models. Further, the spectrum shape feature calculation unit 23 may calculate different feature values between a feature value used by the likelihood ratio calculation unit 24 and a feature value used by the posterior probability calculation unit 61. In a third frame group, at least one of a frame length and a frame shift length may be different from a first frame group and/or a second frame group, or may match the first frame group and/or the second frame group.

As a voice model to be used, the posterior probability calculation unit 61 may use, for example, a Gaussian mixture model learned for each phoneme (phoneme GMM). The posterior probability calculation unit 61 may learn a phoneme GMM by use of, for example, learning voice data assigned with phoneme labels such as /a/, /i/, /u/, /e/, /o/. By assuming that the prior probability of each phoneme p(qk) to be identical regardless of phoneme k, the posterior probability calculation unit 61 is able to calculate the posterior probability p(qk|xt) of a phoneme qk at a time t by use of equation 2 using the likelihood p(xtlqk) of a phoneme GMM.

$$p ( {q}_{k} \vert {x}_{t} ) = \frac{p ( {x}_{t} \vert {q}_{k} )}{{\sum }_{q} p ( {x}_{t} \vert q )} \qquad [ Equation 2 ]$$

A calculation method of the phoneme posterior probability is not limited to a method using a GMM. For example, the posterior probability calculation unit 61 may learn a model directly calculating the phoneme posterior probability by use of a neural network.

Further, without assigning phoneme labels to learning voice data, the posterior probability calculation unit 61 may automatically learn a plurality of models corresponding to phonemes from the learning data. For example, the posterior probability calculation unit 61 may learn a GMM by use of learning voice data including only human voice, and simulatively consider each of the learned Gaussian distributions as a phoneme model. For example, when the posterior probability calculation unit 61 learns a GMM with a number of mixture components being 32, the 32 learned single Gaussian distributions can be simulatively considered as a model representing features of a plurality of phonemes. A “phoneme” in this context is different from a phoneme phonologically defined by humans. However, a “phoneme” according to the third exemplary embodiment may be, for example, a phoneme automatically learned from learning data, in accordance with the method described above.

The posterior-probability-based feature calculation unit 62 includes an entropy calculation unit 621 and a time difference calculation unit 622. The entropy calculation unit 621 performs a process of calculating the entropy E(t) at a time t for respective third frames by use of equation 3 using the posterior probability p(qk|xt) of a plurality of phonemes calculated by the posterior probability calculation unit 61.

$$E ( t ) = - {\sum }_{k} p ( {q}_{k} \vert {x}_{t} ) log ( {q}_{k} \vert {x}_{t} ) \qquad [ Equation 3 ]$$

The entropy of the phoneme posterior probability becomes smaller as the posterior probability becomes more concentrated on a specific phoneme. In a voice section composed of a sequence of phonemes, the posterior probability is concentrated on a specific phoneme, and therefore the entropy of the phoneme posterior probability is small. By contrast, in a non-voice section, the posterior probability is less likely to be concentrated on a specific phoneme, and therefore the entropy of the phoneme posterior probability is large.

The time difference calculation unit 622 calculates the time difference D(t) at a time t for each third frame by use of equation 4 using the posterior probability p(qk|xt) of a plurality of phonemes calculated by the posterior probability calculation unit 61.

$$D ( t ) = {\sum }_{k} {\{ p ( {q}_{k} \vert {x}_{t} ) - p ( {q}_{k} \vert {x}_{t - 1} ) \}}^{2} \qquad [ Equation 4 ]$$

A calculating method of the time difference of the phoneme posterior probability is not limited to equation 4. For example, instead of calculating a square sum of time difference values of each phoneme posterior probability, the time difference calculation unit 622 may calculate a sum of absolute time difference values.

The time difference of the phoneme posterior probability becomes larger as time variation of a posterior probability distribution becomes larger. In a voice section, phonemes continually change in a short time of several tens of milliseconds. Consequently, the time difference of the phoneme posterior probability is large. By contrast, in a non-voice section, features do not greatly change in a short time from a phoneme point of view. Consequently, the time difference of the phoneme posterior probability is small.

The rejection unit 63 determines whether to output a section determined as target voice by the integration unit 27 (target voice section) as a final detection section or not to output the section as reject (take as a section not being a target voice section), by use of at least one of the entropy or the time difference of the phoneme posterior probability respectively calculated by the posterior-probability-based feature calculation unit 62. In other words, the rejection unit 63 specifies a section to be changed to a section not including target voice out of target voice sections determined by the integration unit 27, by use of at least one of the entropy and the time difference of the posterior probability. A section determined as target voice by the integration unit 27 (target voice section) is hereinafter referred to as “tentative detection section.”

As described above, there is a feature in a voice section that the entropy of the phoneme posterior probability is small and the time difference of the phoneme posterior probability is large. There is an opposite feature in a non-voice section. Consequently, the rejection unit 63 is able to classify a tentative detection section output from the integration unit 27 as voice or non-voice by use of one or both of the entropy and the time difference.

The rejection unit 63 may calculate averaged entropy by averaging the entropy of the phoneme posterior probability in a tentative detection section output from the integration unit 27. Similarly, the rejection unit 63 may calculate averaged time difference by averaging the time difference of the phoneme posterior probability in a tentative detection section. Then, the rejection unit 63 may classify whether the tentative detection section is voice or non-voice by use of the averaged entropy and the averaged time difference. In other words, the rejection unit 63 may calculate an average value of at least one of the entropy and the time difference of the posterior probability for each of a plurality of tentative detection sections separated from one another in an acoustic signal. Then, the rejection unit 63 may determine whether to take each of the plurality of tentative detection sections as a section not including target voice or not by use of the calculated average value.

Although, as described above, the entropy of the phoneme posterior probability tends to be small in a voice section, some frame having large entropy exists. By averaging the entropy in a plurality of frames across an entire tentative detection section, the rejection unit 63 is able to determine whether the entire tentative detection section is voice or non-voice with yet higher precision. Similarly, although the time difference of the phoneme posterior probability tends to be large in a voice section, some frame having small time difference exists. By averaging the time difference in a plurality of frames across an entire tentative detection section, the rejection unit 63 is able to determine whether the entire tentative detection section is voice or non-voice with yet higher precision.

As classification of a tentative detection section, the rejection unit 63 may, for example, classify a tentative detection section as non-voice (change to a section not including target voice) when at least one or both of the following conditions are met: the averaged entropy is larger than a predetermined threshold value, and the averaged time difference is less than another predetermined threshold value.

As another classification method of a tentative detection section, the rejection unit 63 may classify whether a tentative detection section is voice or non-voice (specify a section to be changed to a section not including target voice in the tentative detection section) by use of a classifier taking at least one of the averaged entropy and the averaged time difference as a feature. In other words, the rejection unit 63 may specify a section to be changed to a section not including target voice out of target voice sections determined by the integration unit 27, by use of a classifier classifying voice or non-voice, in accordance with at least one of the entropy and the time difference of the posterior probability. As a classifier, the rejection unit 63 may use a GMM, logistic regression, a support vector machine, or the like. As learning data for a classifier, the rejection unit 63 may use learning acoustic data composed of a plurality of acoustic signal sections labeled with voice or non-voice.

Further, more preferably, the rejection unit 63 applies the speech detection device 10 according to the first exemplary embodiment to a first learning acoustic signal including a plurality of target voice sections. Then, the rejection unit 63 takes a plurality of detection sections (target voice sections), separated from one another in an acoustic signal determined as target voice by the integration unit 27 in the speech detection device 10 according to the first exemplary embodiment, as a second learning acoustic signal. Then, the rejection unit 63 may take data labeled with voice or non-voice for each section in the second learning acoustic signal as learning data for a classifier. By thus providing learning data for a classifier, the speech detection device 10 according to the first exemplary embodiment is able to learn a classifier dedicated to classifying an acoustic signal determined as voice, and therefore the rejection unit 63 is able to make yet more precise determination. By applying the speech detection device 10 according to the first exemplary embodiment to a learning acoustic signal, the classifier may be learned so as to determine whether each of a plurality of target voice sections separated from one another in an acoustic signal is a section not including target voice or not.

In the speech detection device 10 according to the third exemplary embodiment, the rejection unit 63 determines whether a tentative detection section output from the integration unit 27 is voice or non-voice. Then, when the rejection unit 63 determines the tentative detection section as voice, the speech detection device 10 according to the third exemplary embodiment outputs the tentative detection section as a detection result of target voice (outputs as a target voice section). When the rejection unit 63 determines the tentative detection section as non-voice, the speech detection device 10 according to the third exemplary embodiment rejects the tentative detection section and does not output the section as a voice detection result (outputs as a section not being a target voice section).

[Operation Example]

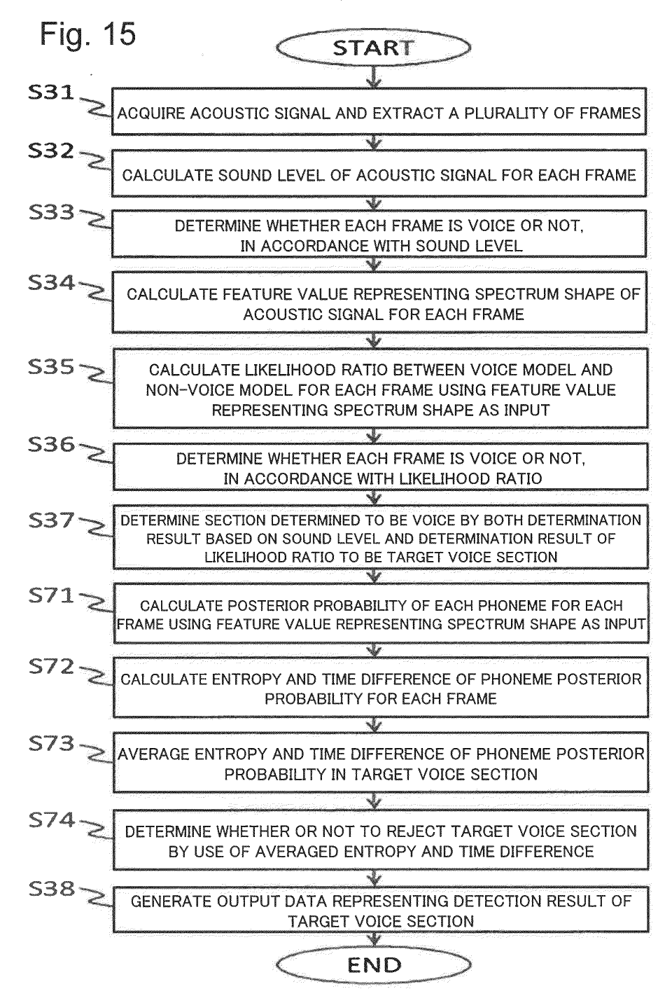

A speech detection method according to the third exemplary embodiment will be described below by use of FIG. 15. FIG. 15 is a flowchart illustrating an operation example of the speech detection device according to the third exemplary embodiment. In FIG. 15, a same reference sign as FIG. 4 is given to a same step indicated in FIG. 4. Description of a same step is omitted.

In S71, the speech detection device 10 calculates the posterior probability of a plurality of phonemes for each third frame by use of the voice model 241 with a feature value calculated in S34 as an input. The voice model 241 is created in advance, in accordance with learning by use of a learning acoustic signal.

In S72, the speech detection device 10 calculates the entropy and the time difference of the phoneme posterior probability for each third frame by use of the phoneme posterior probability calculated in S71.

In S73, the speech detection device 10 calculates average values of the entropy and the time difference of the phoneme posterior probability calculated in S72 in a section determined as a target voice section in S37.

In S74, the speech detection device 10 classifies whether a section determined as a target voice section in S37 is voice or non-voice by use of the averaged entropy and the averaged time difference calculated in S73. Then, when classifying the section as voice, the speech detection device 10 outputs the section as a target voice section, and, when classifying the section as non-voice, does not output the section as a target voice section.

### Operations and Effects of Third Exemplary Embodiment

As described above, the third exemplary embodiment first tentatively detects a target voice section based on sound level and likelihood ratio, and then determines whether the tentatively detected target voice section is voice or non-voice by use of the entropy and the time difference of the phoneme posterior probability. Therefore, the third exemplary embodiment is able to detect a target voice section with high precision even in a situation in which there exists noise that causes determination based on sound level and likelihood ratio to erroneously detect a voice section. The reason that the speech detection device 10 according to the third exemplary embodiment is able to detect target voice with high precision in a situation in which various types of noise exist will be described in detail below.

As a common feature of a technique of detecting a voice section by use of a voice-to-non-voice likelihood ratio as is the case with the speech detection device 10 according to the first exemplary embodiment, there is a problem that voice detection precision decreases when noise is not learned as a non-voice model. Specifically, the technique erroneously detects a noise section, not learned as a non-voice model, as a voice section.

The speech detection device 10 according to the third exemplary embodiment performs a process of determining whether a section is voice or non-voice by use of knowledge of a non-voice model (the likelihood ratio calculation unit 24 and the second voice determination unit 26) and processing of determining whether a section is voice or non-voice without use of any knowledge of a non-voice model but by use of properties of voice only (the posterior probability calculation unit 61, the posterior-probability-based feature calculation unit 62, and the rejection unit 63). Therefore, the speech detection device 10 according to the third exemplary embodiment is capable of determination very robust to a noise type. Properties of voice refer to the aforementioned two features, that is, voice is composed of a sequence of phonemes, and phonemes continually change in a short time of several tens of milliseconds in a voice section. Determining whether an acoustic signal section has the two features, in accordance with the entropy and the time difference of the phoneme posterior probability, enables determination independent of a noise type.

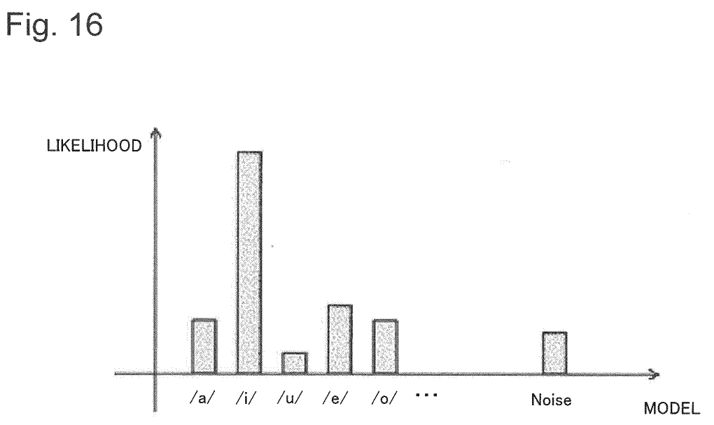

By use of FIGS. 16 to 18, effectiveness of the entropy of the phoneme posterior probability for distinction between voice and non-voice will be described below. FIG. 16 is a diagram illustrating a specific example of the likelihood of a voice model (a phoneme model with phonemes /a/, /i/, /u/, /e/, /o/, . . . is large in the drawing), and a non-voice model (Noise model in the drawing) in a voice section. As illustrated, in the voice section, the likelihood of the voice model is large (likelihood of the phoneme /i/ is large in the drawing), and therefore the voice-to-non-voice likelihood ratio is large. Therefore, the section may be correctly determined as voice, in accordance with the likelihood ratio.

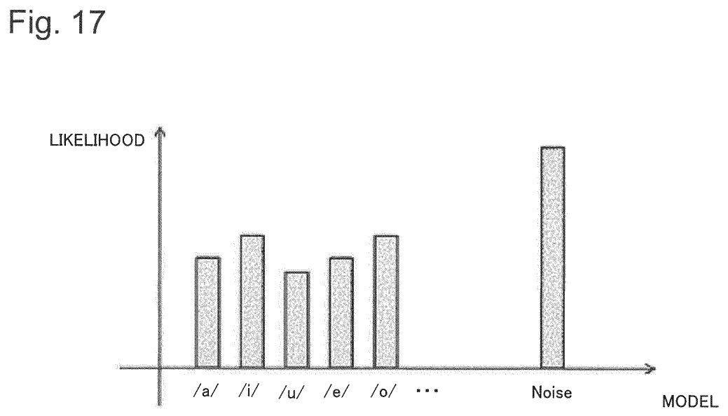

FIG. 17 is a diagram illustrating a specific example of the likelihood of a voice model and a non-voice model in a noise section including noise learned as a non-voice model. As illustrated, in the learned noise section, the likelihood of the non-voice model is large, and therefore the voice-to-non-voice likelihood ratio is small. Therefore, the speech detection device 10 according to the third exemplary embodiment is able to correctly determine the section as non-voice, in accordance with the likelihood ratio.

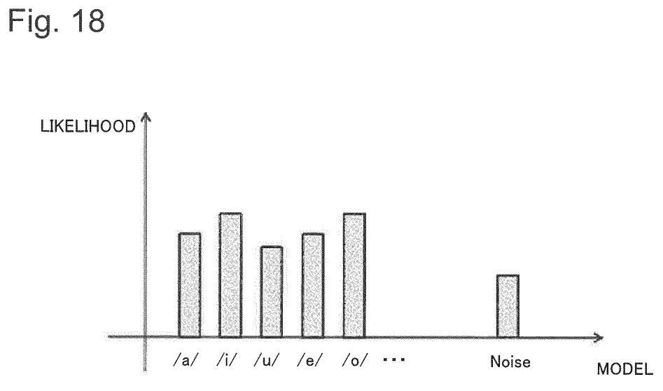

FIG. 18 is a diagram illustrating a specific example of the likelihood of a voice model and a non-voice model in a noise section including noise not learned as a non-voice model. As illustrated, in the unlearned noise section, the likelihood of the non-voice model as well as the likelihood of the voice model is small, and therefore the voice-to-non-voice likelihood ratio is not sufficiently small, and, in some cases, may have a considerably large value. Therefore, determination only by use of the likelihood ratio causes the unlearned noise section to be erroneously determined as a voice section.

However, as illustrated in FIGS. 17 and 18, in a noise section, the posterior probability of any specific phoneme does not have an outstandingly large value, and the posterior probability is dispersed over a plurality of phonemes. In other words, the entropy of the phoneme posterior probability is large. By contrast, as illustrated in FIG. 16, in a voice section, the posterior probability of a specific phoneme has an outstandingly large value. In other words, the entropy of the phoneme posterior probability is small. By taking advantage of this feature, the speech detection device 10 according to the third exemplary embodiment is able to distinguish between voice and non-voice.

The present inventors discovered that, in order to correctly classify voice and non-voice, in accordance with the entropy and the time difference of the phoneme posterior probability, averaging of the entropy and the time difference for a time length of at least several hundreds of milliseconds is required. In order to make the most of such a property, the speech detection device 10 according to the third exemplary embodiment first determines each start point and end point (such as a starting frame and an end frame, and a time point specified by an elapsed time from the head of an acoustic signal) of a plurality of tentative detection sections (target voice sections specified by the integration unit 27) by use of sound level and likelihood ratio. The speech detection device 10 according to the third exemplary embodiment has a processing configuration that subsequently determines, for each tentative detection section, whether or not to reject the tentative detection section (whether the tentative detection section remains as a target voice section or changed to a section not being a target voice section) by use of the entropy and the time difference of the phoneme posterior probability. Therefore, the speech detection device 10 according to the third exemplary embodiment is able to detect a target voice section with high precision even in an environment in which various types of noise exist.

### Modified Example 1 of Third Exemplary Embodiment

The time difference calculation unit 622 may calculate the time difference of the phoneme posterior probability by use of equation 5.

$$D ( t ) = {\sum }_{k} {\{ p ( {q}_{k} \vert {x}_{t} ) - p ( {q}_{k} \vert {x}_{t - n} ) \}}^{2} \qquad [ Equation 5 ]$$

Note that n denotes a frame interval for calculating the time difference and is preferably set to a value close to a typical phoneme interval in voice. For example, assuming that a phoneme interval is approximately 100 msec and a frame shift length is 10 msec, the time difference calculation unit 622 may set n=10. The present modified example causes the time difference of the phoneme posterior probability in a voice section to have a larger value and increases precision of distinction between voice and non-voice.

### Modified Example 2 of the Third Exemplary Embodiment

When processing an acoustic signal input in real time to detect a target voice section, the rejection unit 63 may, in a state that the integration unit 27 determines only a starting end of a target voice section, treat the part after the starting end as a tentative detection section and determine whether the tentative detection section is voice or non-voice. Then, when determining the tentative detection section as voice, the rejection unit 63 outputs the tentative detection section as a target voice detection result with only the starting end determined. The present modified example is able to start processing, for example, in which the processing starts after a starting end of a target voice section is detected, such as speech recognition, at an early timing before a finishing end is determined, while suppressing erroneous detection of the target voice section.

It is preferred that the rejection unit 63 according to the present modified example starts determining whether a tentative detection section is voice or non-voice after a certain amount of time such as several hundreds of milliseconds elapses after the integration unit 27 determines a starting end of a target voice section. The reason is that at least several hundreds of milliseconds are required in order to determine voice and non-voice with high precision, in accordance with the entropy and the time difference of the phoneme posterior probability.

### Modified Example 3 of Third Exemplary Embodiment

The posterior probability calculation unit 61 may calculate the posterior probability only for a section determined as target voice by the integration unit 27 (target voice section). In this case, the posterior-probability-based feature calculation unit 62 calculates the entropy and the time difference of the phoneme posterior probability only for a section determined as target voice by the integration unit 27 (target voice section). The present modified example operates the posterior probability calculation unit 61 and the posterior-probability-based feature calculation unit 62 only for a section determined as target voice by the integration unit 27 (target voice section), and therefore is able to greatly reduce a calculation amount. The rejection unit 63 determines whether a section determined as voice by the integration unit 27 is voice or non-voice, and therefore the present modified example is able to reduce a calculation amount while outputting a same detection result.

### Modified Example 4 of Third Exemplary Embodiment

The speech detection device 10 according to the third exemplary embodiment may be based on the configurations according the second exemplary embodiment illustrated in FIGS. 6 and 13, and further include the posterior probability calculation unit 61, the posterior-probability-based feature calculation unit 62 and the rejection unit 63.

### Fourth Exemplary Embodiment

When the first, second or third exemplary embodiments is configured by use of a program, a fourth exemplary embodiment is provided as a computer operating in accordance with the program.

[Processing Configuration]

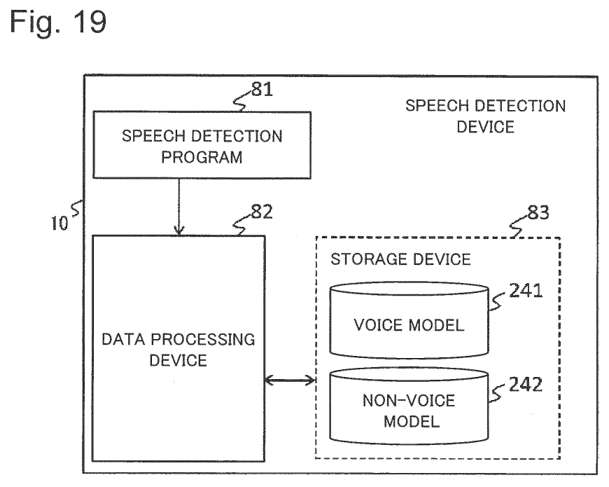

FIG. 19 is a diagram conceptually illustrating a processing configuration example of a speech detection device 10 according to the fourth exemplary embodiment. The speech detection device 10 according to the fourth exemplary embodiment includes a data processing device 82 including a CPU, a storage device 83 configured with a magnetic disk, a semiconductor memory, or the like, a speech detection program 81, and the like. The storage device 83 stores a voice model 241, a non-voice model 242, and the like.

The speech detection program 81 implements a function according to the first, second, or third exemplary embodiment on the data processing device 82 by being read by the data processing device 82 and controlling an operation of the data processing device 82. In other words, the data processing device 82 performs a process of the acoustic signal acquisition unit 21, the sound level calculation unit 22, the spectrum shape feature calculation unit 23, the likelihood ratio calculation unit 24, the first voice determination unit 25, the second voice determination unit 26, the integration unit 27, the first sectional shaping unit 41, the second sectional shaping unit 42, the posterior probability calculation unit 61, the posterior-probability-based feature calculation unit 62, the rejection unit 63 and the like, in accordance with control by the speech detection program 81.

The respective aforementioned exemplary embodiments and modified examples may be specified in part or in whole as the following Supplementary Notes. However, the respective exemplary embodiments and the modified examples are not limited to the following description.

Examples of reference exemplary embodiments are described below as Supplementary Notes.

1. A speech detection device includes:

acoustic signal acquisition means for acquiring an acoustic signal; sound level calculation means for performing a process of calculating a sound level for each of a plurality of first frames obtained from the acoustic signal;

first voice determination means for determining a first frame having the sound level greater than or equal to a first threshold value as a first target frame;

spectrum shape feature calculation means for performing a process of calculating a feature value representing a spectrum shape for each of a plurality of second frames obtained from the acoustic signal;

likelihood ratio calculation means for calculating a ratio of a likelihood of a voice model to a likelihood of a non-voice model for each of the plurality of second frames using the feature value as an input;

second voice determination means for determining a second frame having the ratio greater than or equal to a second threshold value as a second target frame; and

integration means for determining, in the acoustic signal, a section included in both a first target section corresponding to the first target frame and a second target section corresponding to the second target frame as a target voice section including a target voice.

2. The speech detection device according to 1 further includes:

first sectional shaping means for performing a shaping process on a determination result of the first voice determination means, and subsequently inputting the determination result after the shaping process to the integration means; and

second sectional shaping means for performing a shaping process on a determination result of the second voice determination means, and subsequently inputting the determination result after the shaping process to the integration means, wherein

the first sectional shaping means performs at least one of

a shaping process of changing the first target frame corresponding to the first target section having a length less than a predetermined value to the first frame not being the first target frame, and

a shaping process of changing, out of first non-target sections that are not being the first target section, the first frame corresponding to a first non-target section having a length less than a predetermined value to the first target frame, and

the second sectional shaping means performs at least one of

a shaping process of changing the second target frame corresponding to the second target section having a length less than a predetermined value to the second frame not being the second target frame, and

a shaping process of changing, out of second non-target sections that are not being the second target section, the second frame corresponding to a second non-target section having a length less than a predetermined value to the second target frame.

3. The speech detection device according to 1 or 2, wherein

the spectrum shape feature calculation means performs the process of calculating the feature value only for the acoustic signal in the first target section.

4. A speech detection method performed by a computer, the method includes:

an acoustic signal acquisition step of acquiring an acoustic signal;

a sound level calculation step of performing a process of calculating a sound level for each of a plurality of first frames obtained from the acoustic signal;

a first voice determination step of determining a first frame having the sound level greater than or equal to a first threshold value as a first target frame;

a spectrum shape feature calculation step of performing a process of calculating a feature value representing a spectrum shape for each of a plurality of second frames obtained from the acoustic signal;

a likelihood ratio calculation step of calculating a ratio of a likelihood of a voice model to a likelihood of a non-voice model for each of the plurality of second frames using the feature value as an input;

a second voice determination step of determining a second frame having the ratio greater than or equal to a second threshold value as a second target frame; and

an integration step of determining, in the acoustic signal, a section included in both a first target section corresponding to the first target frame and a second target section corresponding to the second target frame as a target voice section including a target voice.

4-2. The speech detection method according to 4 further includes:

first sectional shaping step of performing a shaping process on a determination result of the first voice determination step, and subsequently inputting the determination result after the shaping process to the integration step; and

second sectional shaping step of performing shaping processing on a determination result of the second voice determination step, and subsequently inputting the determination result after shaping processing to the integration step, wherein

in the first sectional shaping step, performing at least one of

a shaping process of changing the first target frame corresponding to the first target section having a length less than a predetermined value to the first frame not being the first target frame, and

a shaping process of changing, out of first non-target sections that are not being the first target section, the first frame corresponding to a first non-target section having a length less than a predetermined value to the first target frame, and

in the second sectional shaping step, performing at least one of

shaping processing of changing the second target frame corresponding to the second target section having a length less than a predetermined value to the second frame not being the second target frame, and

shaping processing of changing, out of second non-target sections that are not being the second target section, the second frame corresponding to a second non-target section having a length less than a predetermined value to the second target frame.

4-3. The speech detection method according to 4 or 4-2, wherein

in the spectrum shape feature calculation step, performing the process of calculating the feature value only for the acoustic signal in the first target section.

5. A program for causing a computer to function as:

acoustic signal acquisition means for acquiring an acoustic signal;

sound level calculation means for performing a process of calculating a sound level for each of a plurality of first frames obtained from the acoustic signal;

first voice determination means for determining a first frame having the sound level greater than or equal to a first threshold value as a first target frame;

spectrum shape feature calculation means for performing a process of calculating a feature value representing a spectrum shape for each of a plurality of second frames obtained from the acoustic signal;

likelihood ratio calculation means for calculating a ratio of a likelihood of a voice model to a likelihood of a non-voice model for each of the plurality of second frames using the feature value as an input;

second voice determination means for determining a second frame having the ratio greater than or equal to a second threshold value as a second target frame; and

integration means for determining, in acoustic signal, a section included in both a first target section corresponding to the first target frame and a second target section corresponding to the second target frame as a target voice section including a target voice.

5-2. The program according to 5 further causing the computer to function as:

first sectional shaping means for performing a shaping process on a determination result of the first voice determination means, and subsequently inputting the determination result after the shaping process to the integration means; and

second sectional shaping means for performing a shaping process on a determination result of the second voice determination means, and subsequently inputting the determination result after the shaping process to the integration means, wherein

the first sectional shaping means performs at least one of

a shaping process of changing the first target frame corresponding to the first target section having a length less than a predetermined value to the first frame not being the first target frame, and

a shaping process of changing, out of first non-target sections that are not being the first target section, the first frame corresponding to a first non-target section having a length less than a predetermined value to the first target frame, and

the second sectional shaping means performs at least one of

a shaping process of changing the second target frame corresponding to the second target section having a length less than a predetermined value to the second frame not being the second target frame, and

a shaping process of changing, out of second non-target sections that are not being the second target section, the second frame corresponding to a second non-target section having a length less than a predetermined value to the second target frame.

5-3. The program according to 5 or 5-2, wherein causing the computer to function as:

the spectrum shape feature calculation means performs the process of calculating the feature value only for the acoustic signal in the first target section.

This application is based upon and claims the benefit of priority from Japanese patent application No. 2013-218934, filed on Oct. 22, 2013, the disclosure of which is incorporated herein in its entirety by reference.

What is claimed is:

1. A speech detection device comprising:
an acoustic signal acquisition unit that acquires an acoustic signal;
a sound level calculation unit that calculates a sound level for each of a plurality of first frames obtained from the acoustic signal;
a first voice determination unit that determines a first frame having the sound level greater than or equal to a first threshold value as a first target frame;
a spectrum shape feature calculation unit that calculates a feature value representing a spectrum shape for each of a plurality of second frames obtained from the acoustic signal;
a likelihood ratio calculation unit that calculates a ratio of a likelihood of a voice model to a likelihood of a non-voice model for each of the plurality of second frames using the feature value as an input;
a second voice determination unit that determines a second frame having the ratio greater than or equal to a second threshold value as a second target frame; and
an integration unit that determines, in the acoustic signal, a section included in both a first target section corresponding to the first target frame signal and a second target section corresponding to the second target frame as a target voice section including a target voice.

2. The speech detection device according to claim 1 further comprising:
a first sectional shaping unit that performs a shaping process on a determination result of the first voice determination unit, and subsequently inputting the determination result after the shaping process to the integration unit; and
a second sectional shaping unit that performs a shaping process on a determination result of the second voice determination unit, and subsequently inputting the determination result after the shaping process to the integration unit, wherein
the first sectional shaping unit performs at least one of
a shaping process of changing the first target frame corresponding to the first target section having a length less than a predetermined value to the first frame not being the first target frame, and
a shaping process of changing, out of first non-target sections that are not being the first target section, the first frame corresponding to a first non-target section having a length less than a predetermined value to the first target frame, and
the second sectional shaping unit performs at least one of
a shaping process of changing the second target frame corresponding to the second target section having a length less than a predetermined value to the second frame not being the second target frame, and
a shaping process of changing, out of second non-target sections that are not being the second target section, the second frame corresponding to a second non-target section having a length less than a predetermined value to the second target frame.

3. The speech detection device according to claim 1, wherein
the spectrum shape feature calculation unit calculates the feature value only for the acoustic signal in the first target section.

4. A speech detection method performed by a computer, the method comprising:
acquiring an acoustic signal;
calculating a sound level for each of a plurality of first frames obtained from the acoustic signal;
determining a first frame having the sound level greater than or equal to a first threshold value as a first target frame;
calculating a feature value representing a spectrum shape for each of a plurality of second frames obtained from the acoustic signal;
calculating a ratio of a likelihood of a voice model to a likelihood of a non-voice model for each of the plurality of second frames using the feature value as an input;
determining a second frame having the ratio greater than or equal to a second threshold value as a second target frame; and
determining, in the acoustic signal, a section included in both a first target section corresponding to the first target frame and a second target section corresponding to the second target frame as a target voice section including a target voice.

5. A computer readable non-transitory medium having a computer readable program recorded thereon, wherein the computer readable program, when executed on a computing device, causes the computing device to:
acquire an acoustic signal;
calculate a sound level for each of a plurality of first frames obtained from the acoustic signal;
determine a first frame having the sound level greater than or equal to a first threshold value as a first target frame;
calculates a feature value representing a spectrum shape for each of a plurality of second frames obtained from the acoustic signal;
calculates a ratio of a likelihood of a voice model to a likelihood of a non-voice model for each of the plurality of second frames using the feature value as an input;
determine a second frame having the ratio greater than or equal to a second threshold value as a second target frame; and
determine, in the acoustic signal, a section included in both a first target section corresponding to the first target frame and a second target section corresponding to the second target frame as a target voice section including a target voice.
